(19) United States
(12) Patent Application Publication
(10) Pub. No.: US 2014/0301820 A1
(43) Pub. Date: Oct. 9, 2014

(54) TURBINE ENGINE SHUTDOWN TEMPERATURE CONTROL SYSTEM WITH NOZZLE INJECTION FOR A GAS TURBINE ENGINE

(71) Applicants: Uwe Lohse, Remscheid (DE); Evan C. Landrum, Charlotte, NC (US); Jiping Zhang, Winter Springs, FL (US); Abdullatif M. Chehab, Chuluota, FL (US)

(72) Inventors: Uwe Lohse, Remscheid (DE); Evan C. Landrum, Charlotte, NC (US); Jiping Zhang, Winter Springs, FL (US); Abdullatif M. Chehab, Chuluota, FL (US)

(21) Appl. No.: 13/855,756

(22) Filed: Apr. 3, 2013

(51) Int. Cl. F02C 7/26

(52) U.S. Cl. CPC F02C 7/26
USPC 415/1; 415/115

(57) ABSTRACT

A turbine engine shutdown temperature control system configured to limit thermal gradients from being created within an outer casing surrounding a turbine blade assembly during shutdown of a gas turbine engine is disclosed. By reducing thermal gradients caused by hot air buoyancy within the mid-region cavities in the outer casing, arched and sway-back bending of the outer casing is prevented, thereby reducing the likelihood of blade tip rub, and potential blade damage, during a warm restart of the gas turbine engine. The turbine engine shutdown temperature control system may operate during the shutdown process where the rotor is still powered by combustion gases or during turning gear system operation after shutdown of the gas turbine engine, or both, to allow the outer casing to uniformly, from top to bottom, cool down.

### FIELD OF THE INVENTION

This invention is directed generally to turbine engines, and more particularly to systems enabling warm startups of the gas turbine engines without risk of turbine blade interference with radially outward sealing surfaces.

### BACKGROUND

Typically, gas turbine engines include a compressor for compressing air, a combustor for mixing the compressed air with fuel and igniting the mixture, and a turbine blade assembly for producing power. Combustors often operate at high temperatures that may exceed 2,500 degrees Fahrenheit. Typical turbine combustor configurations expose turbine blade assemblies to these high temperatures. Because of the mass of these large gas turbine engines, the engines take a long time to cool down after shutdown. Many of the components cool at different rates and as a result, interferences develop between various components. The clearance between turbine blade tips and blade rings positioned immediately radially outward of the turbine blades is such a configuration in which an interference often develops. The casing component cools at different rates from top to bottom due to natural convection. As a result, the casings cooling faster at the bottom versus the top, and the casings take on a deformed shape during shutdown prior to being fully cooled. The hotter upper surface of the casing versus the cooler bottom surface causes the casing to thermally bend or bow upwards. If the engine undergoes a re-start during the time the casing is distorted, the blade tips will have a tendency to interfere at the bottom location due to the upward bow. Thus, if it is desired to startup the gas turbine before is has completely cooled, there exists a significant risk of damage to the turbine blades due to turbine blade tip rub from the interference between the turbine blade tips and the vane carrier at the bottom of the engine due to the deformed shape of the outer casing. Thus, a need exists for reducing turbine vane carrier and vane carrier cooling after shutdown.

### SUMMARY OF THE INVENTION

A turbine engine shutdown temperature control system configured to limit thermal gradients from being created within an outer casing surrounding a turbine blade assembly during shutdown of a gas turbine engine is disclosed. By reducing thermal gradients caused by hot air buoyancy within the mid-region cavities in the outer casing, arched and sway-back bending of the outer casing may be prevented, thereby reducing the likelihood of blade tip rub, and potential blade damage, during a warm restart of the gas turbine engine. The turbine engine shutdown temperature control system may also reverse local outer casing vertical temperature gradients in order to opitimize gross casing distortion and turbine blade tip clearances. The turbine engine shutdown temperature control system may operate during the shutdown process where the rotor is still powered by combustion gases or during turning gear system operation after shutdown of the gas turbine engine, or both, to allow the outer casing to uniformly, from top to bottom, cool down. In other embodiments, the turbine engine shutdown temperature control system may operate during normal gas turbine engine operation.

The turbine engine shutdown temperature control system may be formed from a turbine blade assembly having a plurality of rows of turbine blades extending radially outward from a turbine rotor. An outer casing surrounding the turbine blade assembly may have a plurality of inspection orifices in the outer casing above a horizontal axis defining an upper half of the outer casing, whereby the outer casing may partially defines at least one mid-row region cavity. The turbine engine shutdown temperature control system may include one or more nozzles positioned in the outer casing and positioned radially outward from a mid-row region of a turbine blade assembly. The mid-row region may be positioned downstream from a leading row region and upstream from a downstream row region. The mid-row region cavity may be radially outboard of row three turbine blades. Further, the mid-row region cavity may be radially outboard of row four turbine blades. The nozzle may have a spray pattern less than a width of the at least one mid-row region cavity. The nozzle may have a high velocity, low volume nozzle that is configured to emit fluid into the mid-row region cavity.

The nozzle may be offset circumferentially from top dead center of the outer casing. In at least one embodiment, the nozzle maybe offset from top dead center and may be positioned anywhere within the tiop section of the casing. In another embodiment, the nozzle may be offset circumferentially from top dead center of the outer casing such that the nozzle is positioned between 45 degrees and 75 degrees from top dead center of the outer casing. The nozzle may be positioned such that fluid exhausted from the nozzle impinges on an inner surface of the outer casing. In particular, the nozzle may be positioned such that fluid exhausted from the nozzle impinges on an inner surface of the outer casing at top dead center. The nozzle may be positioned such that fluid exhausted from the nozzle creates a circumferential flow of fluid within the mid-row region cavity in the outer casing.

The turbine engine shutdown temperature control system may be used to retrofit gas turbine engines or within new gas turbine engines. In at least one embodiment, the nozzle may be coupled to the outer casing in a boroscope port, other available preexisting orifice or may be coupled to an orifice created solely for the nozzle. More particularly, the nozzle may be releasably coupled to the outer casing in a boroscope port. The turbine engine shutdown temperature control system may include an ambient air supply in communication with the at least one nozzle for supplying ambient air to the nozzle.

In at least one embodiment, the turbine engine shutdown temperature control system may include at least one nozzle formed from a first nozzle extending from the outer casing into the mid-row region cavity on a first side of top dead center of the outer casing and a second nozzle extending from the outer casing into the mid-row region cavity on a second side of top dead center of the outer casing. The second side may be on an opposite side from the first side. The first and second nozzles may be directed toward the top dead center of the outer casing.

An advantage of the turbine engine shutdown temperature control system is that the system limits thermal gradients caused by hot air buoyancy within the mid-region cavities in the outer casing, arched and sway-back bending of the outer casing may be prevented, thereby reducing the likelihood of blade tip rub, and potential blade damage, during a warm restart of the gas turbine engine.

Another advantage of the turbine engine shutdown temperature control system is that the system may reverse local outer casing vertical temperature gradients in order to opitimize gross casing distortion and turbine blade tip clearances.

Still another advantage of the turbine engine shutdown temperature control system is that the system may be installed in currently existing gas turbine engines, thereby making gas turbine engines that are currently in use more efficient by enabling warm startups to occur rather than waiting days for the gas turbine engines to cool enough for a safe startup.

Another advantage of the turbine engine shutdown temperature control system is that the system helps to mitigate vertical gradients within the outer casing.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a cross-sectional side view of a gas turbine engine including a turbine engine shutdown temperature control system.

FIG. 2 is an axial view of an outer case with the turbine engine shutdown temperature control system taken at section line 2-2 in FIG. 1.

FIG. 3 is a top view of an upper half of the outer case removed from the gas turbine engine.

FIG. 4 is a partial cross-sectional view of a nozzle inserted into a mid-row region cavity radially outboard from a row three turbine blade assembly.

FIG. 5 is a partial cross-sectional view of a nozzle inserted into a mid-row region cavity radially outboard from a row four turbine blade assembly.

FIG. 6 is an axial view of an outer case with the turbine engine shutdown temperature control system taken at section line 6-6 in FIG. 1.

FIG. 7 is an axial view of an outer case with another embodiment of the turbine engine shutdown temperature control system taken at section line 6-6 in FIG. 1.

FIG. 8 is a detail, cross-sectional view of a multiexhuast nozzle, as shown in FIG. 7.

### DETAILED DESCRIPTION OF THE INVENTION

As shown in FIGS. 1-8, a turbine engine shutdown temperature control system 10 configured to limit thermal gradients from being created within an outer casing 12 surrounding a turbine blade assembly 14 during shutdown of a gas turbine engine 16 is disclosed. By reducing thermal gradients caused by hot air buoyancy within the mid-region cavities 18 in the outer casing 12, arched and sway-back bending of the outer casing 12 may be prevented, thereby reducing the likelihood of blade tip rub, and potential blade damage, during a warm restart of the gas turbine engine 16. The turbine engine shutdown temperature control system 10 may also reverse local outer casing vertical temperature gradients in order to opitimize gross casing distortion and turbine blade tip clearances. The turbine engine shutdown temperature control system 10 may operate during the shutdown process where the rotor is still powered by combustion gases or during turning gear system operation after shutdown of the gas turbine engine 16, or both, to allow the outer casing 12 to uniformly, from top to bottom, cool down. In other embodiments, the turbine engine shutdown temperature control system 10 may operate during normal gas turbine engine operation.

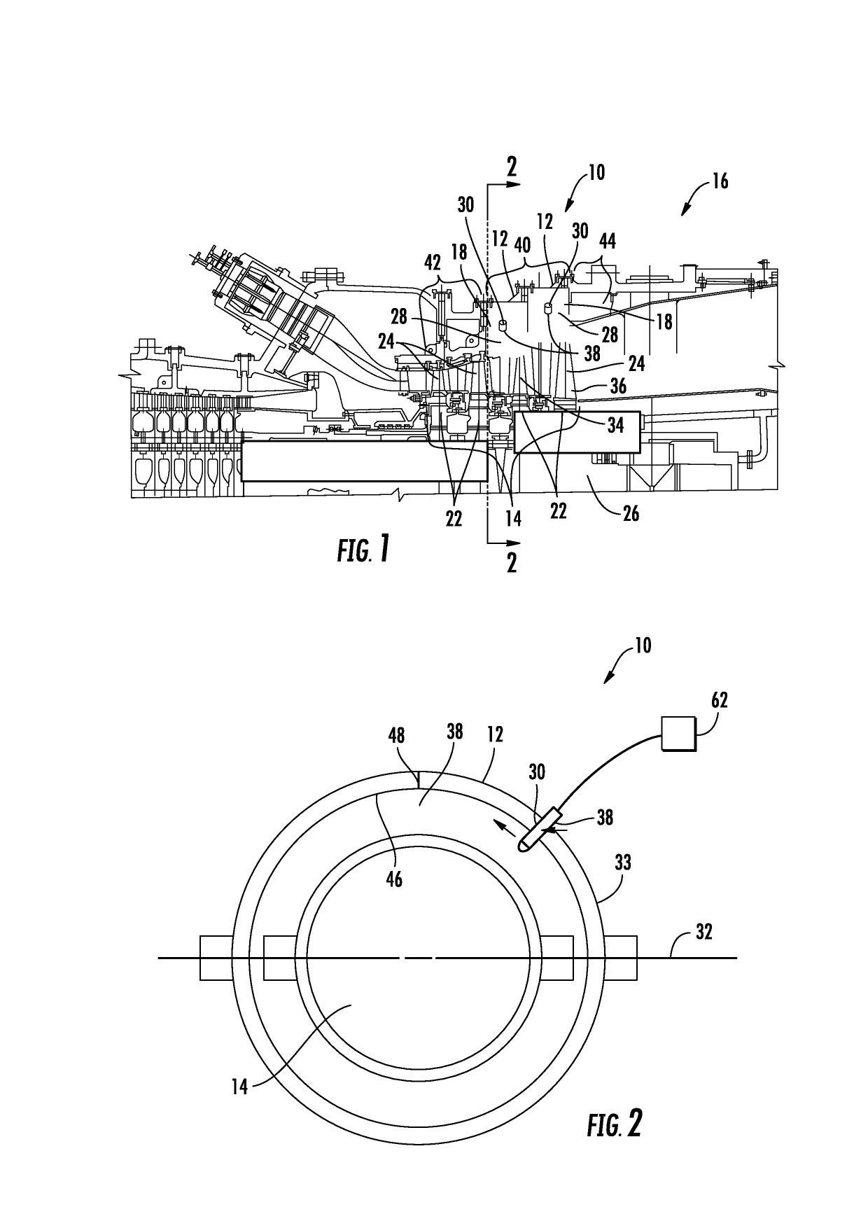

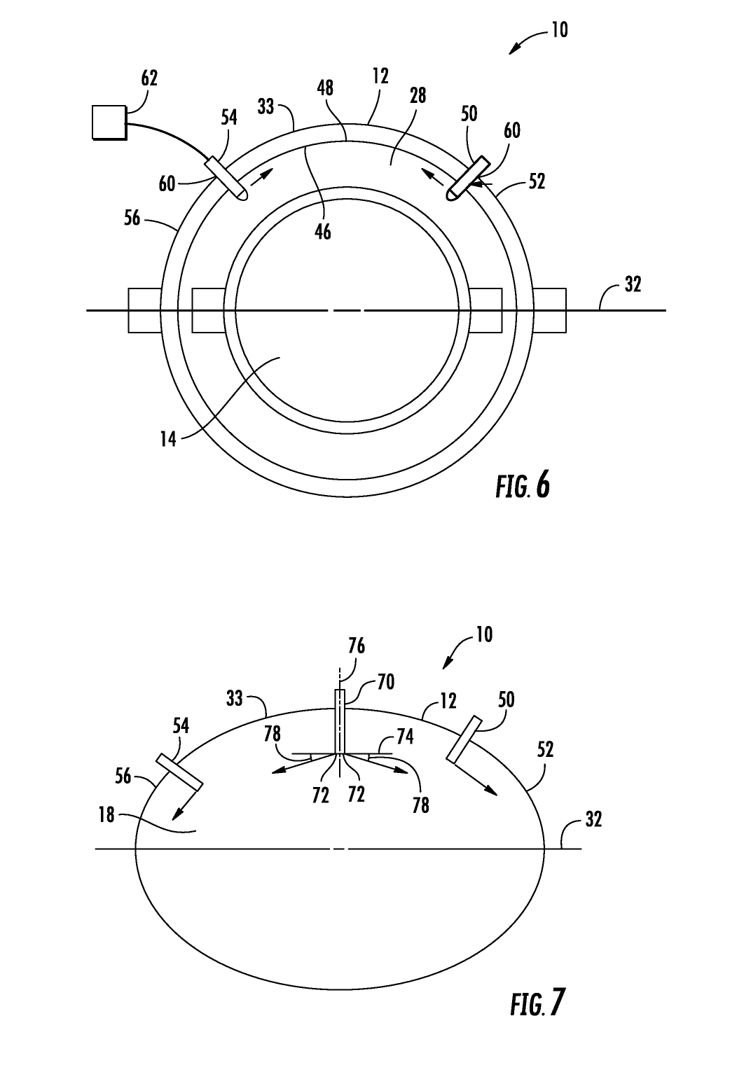

The turbine engine shutdown temperature control system 10 may include a turbine blade assembly 20 having a plurality of rows 22 of turbine blades 24 extending radially outward from a turbine rotor 26. The outer casing 12 may form an internal cavity 28 between the outer casing 12 and blade rings. The outer casing 12 surrounding the turbine blade assembly 14 having a plurality of inspection orifices 30 in the outer casing 12 above a horizontal axis 32 defining an upper half 33 of the outer casing 12. The outer casing 22 may at least partially define at least one mid-row region cavity 18. The mid-row region cavity 18 may be positioned radially outward from row three turbine blades 34, as shown in FIGS. 1 and 4, or row four turbine blades 36, as shown in FIGS. 1 and 5, or both. The mid-region cavity 18 may extend circumferentially about the turbine blade assembly 14 and may be positioned within the outer casing 12. The outer casing may be a single, unobstructed cavity 28, as shown in FIG. 2, or may include multiple partitions forming partitioned cavities within the outer casing 12.

As shown in FIGS. 2-5, the turbine engine shutdown temperature control system 10 may include one or more nozzles 38 positioned in an outer casing of the gas turbine engine 16. The nozzles 38 may extend into a cavity 18 positioned in any appropriate position radially outward of a turbine blade assembly 14 within the gas turbine engine 16. In at least one embodiment, one or more nozzles 38 may be positioned in the outer casing 12 and positioned radially outward from a mid-row region of a turbine blade assembly 14. The mid-row region 40 may be positioned downstream from a leading row region 42 and upstream from a downstream row region 44. The nozzle 38 may be configured to exhaust fluids, such as, but not limited to, air, at a high pressure and low volume. In one embodiment, an ambient air supply 62 may be in communication with the nozzle 38 to supply air to the nozzle 38. The air may be colder than a temperature of the outer casing 12. The nozzle 38 may be a high velocity, low volume nozzle 38 that is configured to emit fluid into the mid-row region cavity 18 within the outer casing 12. In at least one embodiment, the nozzle 38 may be a high velocity, low volume nozzle 38 that is configured to emit fluid into the mid-row region cavity 18 within the outer casing 12 at a pressure ratio of 6:1 at turning gear operation of 120 revolutions per minute. In other embodiments, other pressure ratios and speeds may be used.

The nozzle 38 may be positioned such that fluid exhausted from the nozzle 38 impinges on an inner surface 46 of the outer casing 12. In at least one embodiment, the nozzle 38 may be positioned such that fluid exhausted from the nozzle 38 impinges on the inner surface 46 of the outer casing 12 at top dead center 48 of the outer casing 12. The nozzle 38 may have a spray pattern of fluid less than a width of the mid-row region cavity 18. It is preferable that fluid exhausted from the nozzle impinge on the outer casing 12 and not on blade rings and other components radially inward of the outer casing 12 to keep from developing thermal gradients within those components because of unnecessary cooling. The nozzle 38 may be positioned to spray fluid circumferentially within the cavity 18 to create a circumferential flow pattern therein.

In at least one embodiment, as shown in FIG. 2, the nozzle 38 may be offset circumferentially from top dead center 48 of the outer casing 12. In particular, the nozzle 38 may be offset circumferentially from top dead center 48 of the outer casing such that the nozzle 38 is positioned between 45 degrees and 75 degrees from top dead center of the outer casing 12. In one embodiment, the nozzle may be offset circumferentially from top dead center 48 of the outer casing 12 such that the nozzle 38 is positioned about 60 degrees from top dead center 48 of the outer casing 12. The nozzle 38 may be positioned such that fluid exhausted from the nozzle 38 creates a circumferential flow of fluid within the mid-row region cavity 18 in the outer casing 12.

In another embodiment, as shown in FIG. 6, the nozzle 38 may be formed from a first nozzle 50 extending from the outer casing 12 into the mid-row region cavity 18 on a first side 52 of top dead center 48 of the outer casing 12 and a second nozzle 54 extending from the outer casing 12 into the mid-row region cavity 18 on a second side 56 of top dead center 48 of the outer casing 12. The second side 56 may be positioned on an opposite side from the first side 52. The first and second nozzles 50, 54 may be directed toward the top dead center 48 of the outer casing 12. In one embodiment, the first nozzle 50 may be offset circumferentially from top dead center 48 of the outer casing 12 such that the first nozzle 50 is positioned between 45 degrees and 75 degrees from top dead center 48 of the outer casing 12. In another embodiment, the first nozzle 50 may be offset circumferentially from top dead center 48 of the outer casing 12 such that the first nozzle 50 is positioned about 60 degrees from top dead center 48 of the outer casing 12. Similarly, the second nozzle 54 may be offset circumferentially from top dead center 48 of the outer casing 12 such that the second nozzle 54 is positioned between 45 degrees and 75 degrees from top dead center 48 of the outer casing 12. In another embodiment, the second nozzle 54 may be offset circumferentially from top dead center 48 of the outer casing 12 such that the second nozzle 54 is positioned about 60 degrees from top dead center 48 of the outer casing 12. The first and second nozzles 50, 54 may be positioned as mirror images to each other about the top dead center 48 of the outer casing 12. Alternatively, the first and second nozzles 50, 54 may be positioned in different orientations relative to top dead center 48 of the outer casing 12.

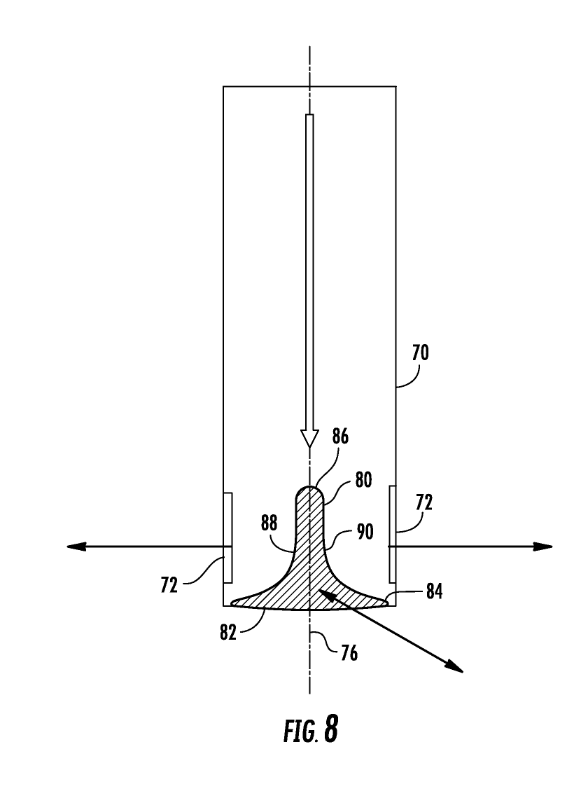

In another embodiment, as shown in FIG. 7, the first nozzle 50 may extend from the outer casing 12 into the mid-row region cavity 18 on a first side 52 of top dead center 48 of the outer casing 12 and the second nozzle 54 may extend from the outer casing 12 into the mid-row region cavity 18 on a second side 56 of top dead center 48 of the outer casing 12. The second side 56 may be positioned on an opposite side from the first side 52. The first and second nozzles 50, 54 may be directed away from the top dead center 48 of the outer casing 12. A multiexhuast nozzle 70 may extend into one or moree cavities within an outer casing 12, such as, but not limited to, the mid-row region cavity 18. The multiexhuast nozzle 70 may include two or more exhaust outlets 72 that are positioned to expel fluid from the nozle 70. The exhaust outlets 72 of the multiexhaust nozzle 70 may face generally away from each other and may be positioned to expel fluid generally orthogonal to a longitudinal axis of the gas turbine engine 16. In at least one embodiment, as shown in FIG. 7, the exhaust outlets 72 may exhaust fluid at a slight angle 78 to an axis 74 orthogonal to a longitudinal axis 76 of the multiexhaust nozzle 70. In another embodiment, as shown in FIG. 8, the exhaust outlets 72 may exhaust fluid orthogonal to a longitudinal axis 76 of the multiexhaust nozzle 70. In one embodiment, the multiexhaust nozzle 70 may be used in combination with the first and second nozzles 50, 54. In another embodiment, the multiexhaust nozzle may be used without the first and second nozzles 50, 54. The multiexhaust nozzle may be positioned at the top dead center 48 of the outer casing 12, as shown in FIG. 7, or may be positioned at other locations in the outer casing 12.

As shown in FIG. 8, the multiexhaust nozzle 70 may include a flow guide 80 positioned at a proximal end 82 of the multiexhaust nozzle 70 to guide fluid to the exhaust outlets 72. The flow guide 80 may have any appropriate configuration. In at least one embodiment, the flow guide 80 may formed in a modified conical shape having an elongated tip 86 that transitions to a wide base 84. The flow guide may also be a nonconical configuration with formed from first and second sides 88, 90, which may be curved or otherwise configured to direct fluid to the exhaust outlets 72. The exhaust outlets 72 may have any appropriate shape.

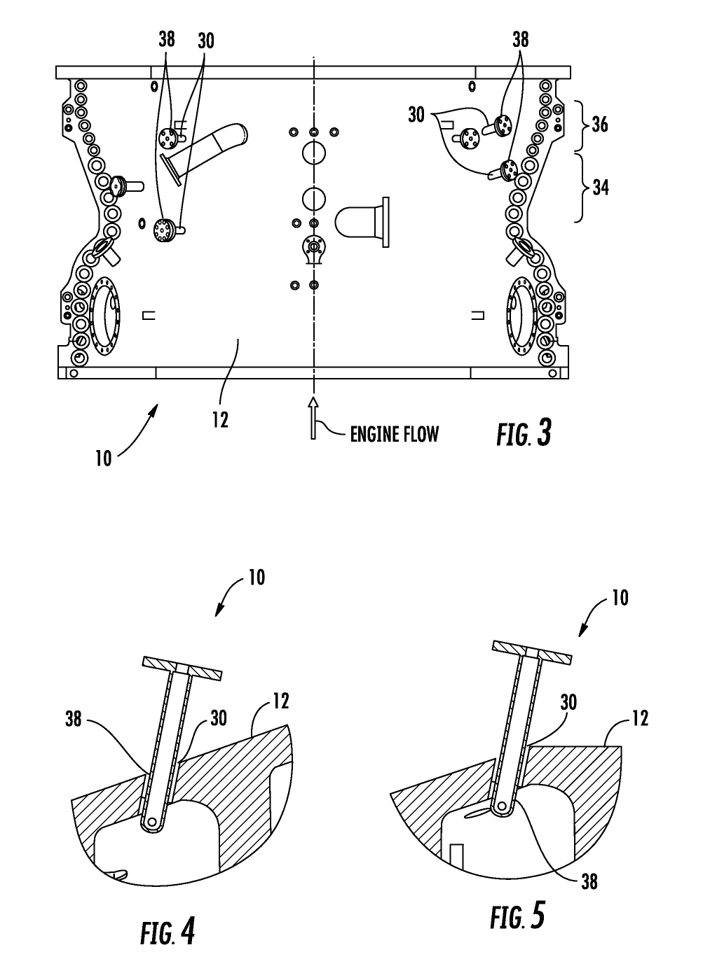

The nozzle 38 may be positioned within an orifice 30 in the outer casing 12. The orifice 30 may be generally circular or have any appropriate shape. In at least one embodiment, the turbine engine shutdown temperature control system 10 may be used to retrofit an existing gas turbine engine 16 or within new gas turbine engines. In such an embodiment, as shown in FIG. 3, the nozzle 38 may be coupled to the outer casing 12 in a boroscope port 60, other available preexisting orifice or may be coupled to an orifice created solely for the nozzle 38. In particular, the nozzle 38 may be releasably coupled to the outer casing 12 in the boroscope port 60.

The turbine engine shutdown temperature control system 10 may be operated during the shutdown process where the rotor is still powered by combustion gases or during turning gear system operation after shutdown of the gas turbine engine, or both. In one embodiment, the turbine engine shutdown temperature control system 10 may be operated with a turning gear system of a gas turbine engine 16. Turning gear systems are operated after shutdown of a gas turbine engine and throughout the cooling process where the gas turbine engine cools without being damaged from components thermally contracting at different rates. One or more nozzles 38 of the turbine engine shutdown temperature control system 10 may exhaust fluid, such as air, into the mid-row region cavity 18 to limit the creation of thermal gradients between top dead center 48 and bottom aspects of the outer casing 12. The slower the turning gear system operation, the larger the volume of air is needed. Such operation prevents the outer casing 12 from bending, including no arched bending and no sway-back bending. The turbine engine shutdown temperature control system 10 may be operated for ten or more hours. Operating the control system 10 for more than 10 hours does not cause any damage to the outer casing 12 or other components of the gas turbine engine 16.

The foregoing is provided for purposes of illustrating, explaining, and describing embodiments of this invention. Modifications and adaptations to these embodiments will be apparent to those skilled in the art and may be made without departing from the scope or spirit of this invention.

I claim:

1. A turbine engine shutdown temperature control system, comprising:
a turbine blade assembly having a plurality of rows of turbine blades extending radially outward from a turbine rotor;
an outer casing surrounding the turbine blade assembly having a plurality of inspection orifices in the outer casing above a horizontal axis defining an upper half of the outer casing, wherein the outer casing partially defines at least one cavity; and
at least one nozzle positioned in the outer casing and positioned radially outward from the turbine blade assembly.

2. The turbine engine shutdown temperature control system of claim 1, wherein the at least one nozzle has a spray pattern less than a width of the at least one mid-row region cavity.

3. The turbine engine shutdown temperature control system of claim 1, wherein the at least one nozzle is offset circumferentially from top dead center of the outer casing.

4. The turbine engine shutdown temperature control system of claim 1, wherein the at least one nozzle is offset circumferentially from top dead center of the outer casing such that the at least one nozzle is positioned between 45 degrees and 75 degrees from top dead center of the outer casing.

5. The turbine engine shutdown temperature control system of claim 1, wherein the at least one nozzle is positioned such that fluid exhausted from the at least one nozzle impinges on an inner surface of the outer casing.

6. The turbine engine shutdown temperature control system of claim 1, wherein the at least one nozzle is positioned such that fluid exhausted from the at least one nozzle impinges on an inner surface of the outer casing at top dead center.

7. The turbine engine shutdown temperature control system of claim 1, wherein the at least one nozzle is positioned such that fluid exhausted from the at least one nozzle creates a circumferential flow of fluid within the cavity in the outer casing.

8. The turbine engine shutdown temperature control system of claim 1, wherein the at least one nozzle is coupled to the outer casing in a boroscope port.

9. The turbine engine shutdown temperature control system of claim 1, wherein the at least one nozzle is a multiexhaust nozzle.

10. The turbine engine shutdown temperature control system of claim 1, further comprising an ambient air supply in communication with the at least one nozzle.

11. The turbine engine shutdown temperature control system of claim 1, wherein the at least one cavity is at least one mid-row region cavity formed by the outer casing and wherein the at least one nozzle is positioned in the outer casing and positioned radially outward from a mid-row region of the turbine blade assembly, wherein the mid-row region is positioned downstream from a leading row region and upstream from a downstream row region.

12. The turbine engine shutdown temperature control system of claim 11, wherein the at least one nozzle is formed from a first nozzle extending from the outer casing into the mid-row region cavity on a first side of top dead center of the outer casing and a second nozzle extending from the outer casing into the mid-row region cavity on a second side of top dead center of the outer casing, wherein the second side is on an opposite side from the first side and wherein the first and second nozzles are directed toward the top dead center of the outer casing.

13. The turbine engine shutdown temperature control system of claim 11, wherein the at least one nozzle is formed from a first nozzle extending from the outer casing into the mid-row region cavity on a first side of top dead center of the outer casing and a second nozzle extending from the outer casing into the mid-row region cavity on a second side of top dead center of the outer casing, wherein the second side is on an opposite side from the first side and wherein the first and second nozzles are directed away from the top dead center of the outer casing.

14. The turbine engine shutdown temperature control system of claim 13, further comprising a multiexhuast nozzle positioned between the first and second nozzles.

15. A method of controlling the temperature of cavity within a gas turbine engine during shutdown of the engine using turbine engine shutdown temperature control system, comprising:
after shutdown of a gas turbine engine has commenced, emitting a fluid from at least one nozzle positioned in the outer casing and positioned radially outward from a turbine blade assembly having a plurality of rows of turbine blades extending radially outward from a turbine rotor;
wherein the at least one nozzle is positioned in an outer casing surrounding the turbine blade assembly having a plurality of inspection orifices in the outer casing above a horizontal axis defining an upper half of the outer casing, wherein the outer casing partially defines at least one cavity into which the fluid is emitted from the at least one nozzle.

16. The method of claim 15, wherein emitting fluid from the at least one nozzle comprises emitting fluid emitting fluid from the at least one nozzle, wherein the at least one cavity is at least one mid-row region cavity formed by the outer casing and wherein the at least one nozzle is positioned in the outer casing and positioned radially outward from a mid-row region of a turbine blade assembly, wherein the mid-row region is positioned downstream from a leading row region and upstream from a downstream row region.

17. The method of claim 16, wherein emitting fluid from the at least one nozzle comprises emitting fluid emitting fluid from the at least one nozzle, wherein the at least one nozzle is formed from a first nozzle extending from the outer casing into the mid-row region cavity on a first side of top dead center of the outer casing and a second nozzle extending from the outer casing into the mid-row region cavity on a second side of top dead center of the outer casing, wherein the second side is on an opposite side from the first side and wherein the first and second nozzles are directed toward the top dead center of the outer casing.

18. The method of claim 16, wherein emitting fluid from the at least one nozzle comprises emitting fluid emitting fluid from the at least one nozzle, wherein the at least one nozzle has a spray pattern less than a width of the at least one mid-row region cavity and wherein the at least one nozzle is positioned such that fluid exhausted from the at least one nozzle creates a circumferential flow of fluid within the mid-row region cavity in the outer casing.

19. The method of claim 16, wherein emitting fluid from the at least one nozzle comprises emitting fluid emitting fluid from the at least one nozzle, wherein the at least one nozzle is offset circumferentially from top dead center of the outer casing such that the at least one nozzle is positioned between 45 degrees and 75 degrees from top dead center of the outer casing, and wherein the at least one nozzle is positioned such that fluid exhausted from the at least one nozzle impinges on an inner surface of the outer casing at top dead center.

20. A turbine engine shutdown temperature control system, comprising:
a turbine blade assembly having a plurality of rows of turbine blades extending radially outward from a turbine rotor;
an outer casing surrounding the turbine blade assembly having a plurality of inspection orifices in the outer casing above a horizontal axis defining an upper half of the outer casing, wherein the outer casing partially defines at least one mid-row region cavity;
at least one nozzle positioned in the outer casing and positioned radially outward from a mid-row region of a turbine blade assembly, wherein the mid-row region is positioned downstream from a leading row region and upstream from a downstream row region;
wherein the at least one nozzle is offset circumferentially from top dead center of the outer casing such that the at least one nozzle is positioned between 45degrees and 75 degrees from top dead center of the outer casing;
wherein the at least one nozzle is positioned such that fluid exhausted from the at least one nozzle impinges on an inner surface of the outer casing;
wherein the at least one nozzle has a spray pattern less than a width of the at least one mid-row region cavity; and
wherein the at least one nozzle is positioned such that fluid exhausted from the at least one nozzle creates a circumferential flow of fluid within the mid-row region cavity in the outer casing.
